(19) United States
(12) Patent Application Publication
(10) Pub. No.: US 2025/0073749 A1
(43) Pub. Date: Mar. 6, 2025

(54) METHOD OF FORMING A VARNISH-COATED IMAGE

(71) Applicant: Canon Production Printing Holding B.V., Venlo (NL)

(72) Inventor: Jeroen A. SCHELL, Venlo (NL)

(73) Assignee: Canon Production Printing Holding B.V., Venlo (NL)

(21) Appl. No.: 18/952,459

(22) Filed: Nov. 19, 2024

Related U.S. Application Data
(63) Continuation of application No. PCT/EP2023/064531, filed on May 31, 2023.

(30) Foreign Application Priority Data
Jun. 2, 2022 (EP) 22176895.5

(51) Int. Cl. B05D 7/26; B05D 7/00

(52) U.S. Cl. CPC B05D 7/26; B05D 7/51; B05D 7/544

(57) ABSTRACT

A printing method includes forming an image by applying marking material onto the surface of a substrate; subjecting the image to a fixation treatment; and applying a layer of an ionically stabilized varnish on the surface of the image. When the image has been formed, a layer of liquid solvent is formed on at least a part of the surface of the image, thereby causing ions to migrate from the marking material into the solvent and then to be absorbed into the substrate together with a part of the solvent before the varnish s applied.

The invention relates to a printing method comprising the steps of:
forming an image by applying marking material onto the surface of a substrate;
subjecting the image to a fixation treatment; and
applying a layer of an ionically stabilized varnish on the surface of the image.

A method of this type has been disclosed in WO 2021201873 A1. The main purpose of over-coating the printed image who is a varnish layer is to improve the gloss of the image.

EP 3 415 334 A1 discloses an ink jet printing method in which the fixation treatment comprises a step of blowing super-heated steam onto the substrate.

WO 2015191305 A1 mentions in the discussion of the prior art, that a varnish layer may also be used for making the printed image less susceptible to smudging or offsetting. However, this document proposes to reduce the susceptibility to smudging or offsetting by subjecting the printed image to a steam fixation treatment rather than over-coating it with a varnish layer.

It is an object of the invention to provide a method of the type described in the opening paragraph with improved control of the gloss of the image.

In order to achieve this object, in the method according to the invention, when the image has been formed, a layer of liquid solvent is formed on at least a part of the surface of the image, thereby causing ions to migrate from the marking material into the solvent and then to be absorbed into the substrate together a part of the solvent before the varnish is applied.

When an ionically stabilized varnish is used for obtaining a high gloss of the image, a degradation of the gloss of the image may be due to a migration of ions from the marking material into the varnish. For example, if the varnish is anionically stabilized, a high gloss is obtained because the anions in the varnish keep the varnish in a fluid state for a time period that is long enough for the varnish to form a smooth surface. Then, if the marking material includes cations, these cations may migrate into the varnish and may cause a premature destabilization of the varnish, so that the flow of the varnish is compromised before a smooth surface has been formed.

In the method according to the invention, the layer of liquid solvent that is formed on the surface of the image causes ions that could destabilize the varnish to migrate from the marking material into the solvent. Then, at least a part of the solvent with the ions dissolved therein will be absorbed into the substrate. In this way, the concentration of detrimental ions in the marking material can be reduced before the varnish is applied.

More specific optional features of the invention are indicated in the dependent claims.

In one embodiment, a pre-treatment liquid, e.g. a primer, may be applied to the surface of the substrate before the printing step in which the marking material is applied. The pre-treatment liquid may for example include Mg⁺⁺ cations or other divalent cations which help to destabilize the marking material that is applied for example in the form of a liquid ink. This has the advantage that the susceptibility of the ink to inter-color bleeding is reduced, so that the image quality can be improved. However, the use of a primer may have the undesired side-effect that cations that have migrated from the primer into the ink remain in the ink and may then migrate further into the varnish where they cause an undesired destabilization of the varnish. In the method according to the invention, however, this side-effect is suppressed by absorbing the residual ions into the substrate before the varnish is applied. In this way, the choice of useable primers and the admissible contents of cations in the primer can be increased without compromising the gloss of the image.

The varnish may be a water-based varnish, and the solvent film in which the ions from the marking material are to be dissolved may be a thin water film that is applied for example by means of a fixation treatment with super-heated steam (SHS).

The layer of varnish may be applied by means of an anilox roller. In that case, the absorption of at least a part of the ions into the substrate will also reduce the contamination of the anilox roller due to destabilized varnish.

In another embodiment, the varnish may be applied by means of ink jet nozzles.

Embodiment examples will now be described in conjunction with the drawings, wherein:

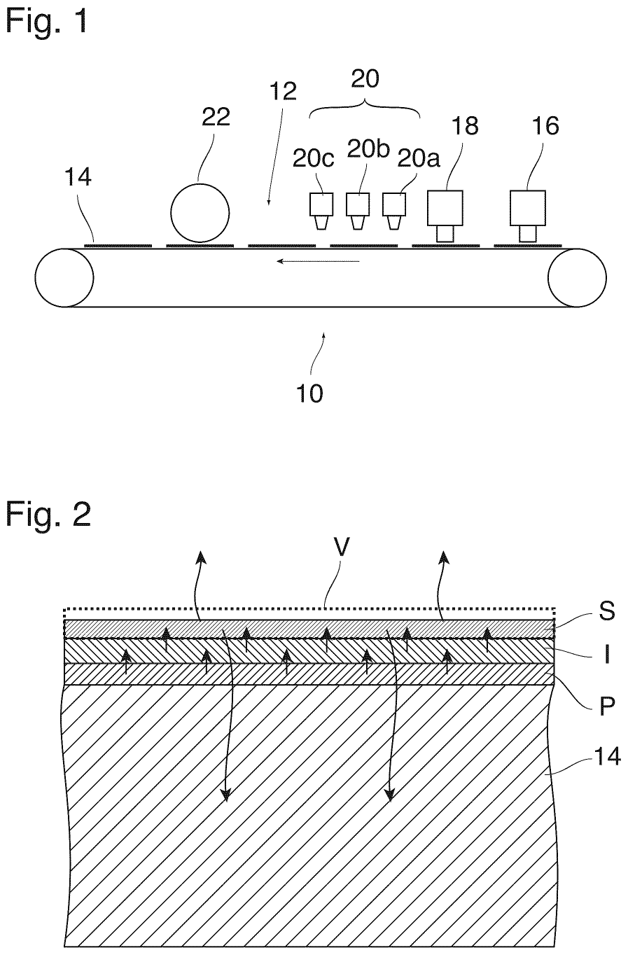

FIG. 1 is a schematic view of a printing system suitable for carrying out the invention;

FIG. 2 is an enlarged sectional view of a portion of a substrate having a primer layer, an ink layer and a solvent layer on its surface;

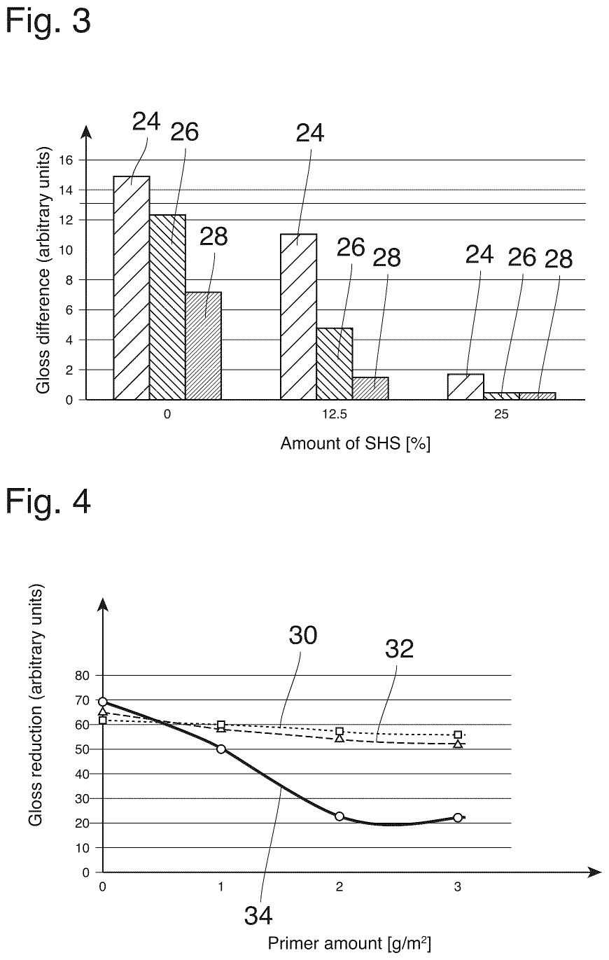

FIG. 3 is a diagram illustrating the effect of the invention on the gloss of the printed image for different settings of the print process; and

FIG. 4 shows graphs indicating the amount of gloss reduction of printed images as a function of an amount of primer for different settings of the fixation treatment.

The printing system shown in FIG. 1 comprises a conveyer 10 that constitutes a transport path 12 for sheet-like print substrates 14. A primer application unit 16, an ink jet print engine 18, a fixation unit 20 and a varnish applicator 22 are disposed in that order in transport direction along the transport path 12.

The primer application unit 16 is for example constituted by an ink jet print head and is configured for applying a uniform or non-uniform layer of a liquid primer onto at least a part of the surface of each substrate 14. The primer may be any known and commercially available primer that is suitable as a pre-processing liquid for printing. Typically, the primer includes one or more salts that contain divalent cations such as Mg⁺⁺.

The print engine 18 comprises a multi-color ink jet print head assembly suitable for forming a printed image on the surface of the substrate 14 or rather on the surface of the primer layer by jetting droplets of ink onto the substrate. The inks of different colors may for example be water-based inks each comprising a dispersion of color pigments. As long as the ink on the substrate is still in the liquid state, cations from the primer layer may dissolve into the ink and cause a desired destabilization of the ink, which reduces the fluidity or mobility of the ink and thereby suppresses a bleeding of ink of one color into a neighboring area of the image carrying ink of a different color.

The fixation unit 20 comprises a hot gas nozzle array 20a on an upstream side, (optionally) a cold gas nozzle array 20b, and an SHS nozzle array 20c on the downstream side. The hot gas nozzle array 20a is configured to blow a stream of hot gases against the surface of the substrates 14 in order to cure the liquid ink and thereby to fix the printed images. The hot gases may comprise hot air with a temperature of 120° C. at a pressure of 20.4 hPa. The cold gas nozzle array 20a bis configured to blow a stream of cold gases against the surface of the substrates 14 in order to cool the substrates. The SHS nozzle array 20c is configured to blow a stream of super-heated steam (SHS) against the substrates. The super-heated steam (water vapor) may have a temperature of 120° C., a pressure of 0.4 hPa and an oxygen content of 13%. With different SHS conditions (temperature, oxygen content) and/or variation in substrate temperature, the amount of water on the surface of the substrates can be controlled via dew point. Optionally, the fixation unit may be configured to vary the ratio of hot air and steam that are jetted-out onto the substrates. In one embodiment, the fixation unit may be configured to uniformly apply the stream of super-heated steam onto the entire surface of the substrate. In another embodiment, the SHS nozzle unit may comprise an array of controllable nozzles by which the treatment conditions (exposure time and/or flow rate of SHS) can be varied locally, so that different parts of the printed image are subjected to different treatments.

When the stream of super-heated steam impinges on the surface of the substrates 14 which have a lower temperature after having left the cold gas nozzle array 20b, the super-heated steam will condense on the surface of the substrate and will thus form a thin film of liquid water with a thickness of e.g. 4 μm on the surface of the printed image. Simultaneously, the substrate 14 will be heated to an elevated temperature.

While the heated substrates travel from the fixation unit 20 to the varnish applicator 22, the water contained in the liquid ink as well as the water that has been applied by the fixation unit 20 will evaporate, so that the ink is cured and the image is fixed on the substrate. As long as a film of water is still present on the surface of the substrate, cations from the primer liquid that have migrated into the ink may migrate further into the film of water. In other words, an excessive amount of salt that may be present in or on the ink layer will be dissolved into the water film.

It will be understood that, as the substrate moves towards the vanish applicator 22, only a part of the water in the film will evaporate while another part of the water will be absorbed into the substrate. The amount of water that is absorbed into the substrate will depend upon the absorptivity of the substrate material which will be high if the substrate is made of paper, for example. Due to this absorption process, a substantial portion of the cations that have been dissolved into the water film will be absorbed into the substrate so that the amount of cations remaining on the surface of the cured image will be reduced significantly.

In the example shown, the varnish applicator 22 comprises an anilox roller that is configured to apply a film of an anionically stabilized water-based varnish onto the surface of the cured image. Since the cations that have remained on the surface of the image tend to migrate into the varnish and to destabilize the varnish, the fluidity and mobility of the liquid varnish will be reduced to some extent, which diminishes the capability of the varnish to form a uniform surface layer before the varnish is set. As a consequence, the gloss of the image will be somewhat reduced due to the premature destabilization of the varnish. However, since the amount of cations present on the surface of the image has been reduced by absorbing most of the cations into the substrate, the degradation of the gloss of the printed image can be kept within acceptable limits, even if the primer that has been applied by the applicator unit 16 had a high concentration of Mg salts in order to suppress inter-color bleeding and improve the quality of the printed color image. In this way, it is possible to obtain printed images which have both, a high image quality and a high gloss.

FIG. 2 is a sectional view of one of the substrates 14 in the state in which it leaves the fixation unit 20. A primer layer P and an ink layer I have been formed on the surface of the substrate, and the super-heated steam that has been applied in the fixation treatment has caused the temporary formation of a layer of solvent(S) (water) on the ink layer. Arrows symbolize the migration of cations from the primer layer P into the ink layer I and further into the solvent S. Part of the solvent with the ions dissolved therein will be absorbed into the substrate 14 and another part of the solvent will evaporate, as has been symbolized by “wavy” arrows. A varnish layer V to be applied later has been indicated in dotted lines.

FIG. 3 is a bar diagram illustrating the reduction in gloss that is caused by the presence of Mg⁺⁺ ions in the primer and the ink, respectively, for different parameters of the fixation treatment process. The bars 24 in FIG. 3 relate to cases in which the coverage of the substrate 14 with primer was 3 g/m², the bars 26 relate to cases where the primer coverage was 2 g/m², and the bars 28 relate to cases where the primer coverage was 1 g/m². The horizontal axis in FIG. 3 represents three different settings for the fixation treatment, wherein the percentage of the exposure time to super-heated steam is 0%, 12.5% and 25%, respectively, to the total treatment time in the fixation unit 20.

It can be seen that the degradation of the gloss of the printed image is largest when the primer coverage is high. This is explained by the fact that, if the primer coverage is high, there are large amounts of Mg⁺⁺ ions that can migrate into the varnish and cause a reduction in gloss. Further, it can be seen in FIG. 3 that the reduction in gloss is efficiently suppressed if the percentage of super-heated steam exposure is increased from 0% to 12.5% and further to 25%.

FIG. 4 shows three curves 30, 32 and 34 which show the reduction of glossiness of the printed images as a function of the primer coverage for three different settings of the fixation treatment process. The curve 30 relates to a case where only hot air and was applied for a time period of 3 s. The curve 32 relates to a case where hot air was applied for 2.25 s and super-heated steam was applied for 0.75 s. In both cases, the reduction in the glossiness of the images is relatively high and the amount of primer coverage has only little impact on the glossiness.

The curve 34 relates to a case where the fixation treatment consisted to 100% of exposure to super-heated steam and was applied for a period of 1 s. While there is only a little or even a negative impact on the glossiness when no primer is used at all, the reduction in glossiness is suppressed significantly when the primer coverage is larger. The improvement is particularly pronounced for primer coverages of 2 g/m² or more.

1. A printing method comprising the steps of:
forming an image by applying marking material onto the surface of a substrate;
subjecting the image to a fixation treatment; and
applying a layer of an ionically stabilized varnish on the surface of the image,
wherein, when the image has been formed, a layer of liquid solvent is formed on at least a part of the surface of the image, thereby causing ions to migrate from the marking material into the solvent and then to be absorbed into the substrate together with a part of the solvent before the varnish is applied.

2. The method according to claim 1, wherein the varnish is an anionically stabilized varnish.

3. The method according to claim 1, wherein a pre-treatment liquid is applied onto the surface of the substrate before the marking material is applied.

4. The method according to claim 2, wherein the pre-treatment liquid contains at least one salt that has divalent cations.

5. The method according to claim 1, wherein the varnish is a water-based varnish.

6. The method according to claim 1, wherein the solvent is water.

7. The method according to claim 6, wherein the fixation treatment comprises exposing the surface of the printed image to an atmosphere that contains water vapor.

8. The method according to claim 7, wherein the fixation treatment comprises a step of blowing hot gas against the surface of the printed image, at least a portion of the hot gas being constituted by super-heated steam.

9. The method according to claim 1, wherein an anilox roller is used for applying the varnish on the surface of the image.

10. A printing system comprising a primer application unit, a print engine, a fixation unit and a varnish applicator disposed in that order along a transport path for print substrates, wherein the fixation unit is configured for blowing super-heated steam against the surface of the substrates.

11. The method according to claim 2, wherein a pre-treatment liquid is applied onto the surface of the substrate before the marking material is applied.

12. The method according to claim 3, wherein the pre-treatment liquid contains at least one salt that has divalent cations.

13. The method according to claim 2, wherein the varnish is a water-based varnish.

14. The method according to claim 3, wherein the varnish is a water-based varnish.

15. The method according to claim 4, wherein the varnish is a water-based varnish.

16. The method according to claim 2, wherein the solvent is water.

17. The method according to claim 3, wherein the solvent is water.

18. The method according to claim 4, wherein the solvent is water.

19. The method according to claim 5, wherein the solvent is water.

20. The method according to claim 2, wherein an anilox roller is used for applying the varnish on the surface of the image.
